(19) United States
(12) Patent Application Publication
(10) Pub. No.: US 2026/0081634 A1
(43) Pub. Date: Mar. 19, 2026

(54) Wireless Circuitry with Isolated Active Combiner

(71) Applicant: Apple Inc., Cupertino, CA (US)

(72) Inventors: Hongrui Wang, San Jose, CA (US); Abbas Komijani, Mountain View, CA (US)

(21) Appl. No.: 18/888,859

(22) Filed: Sep. 18, 2024

(51) Int. Cl. H04B 1/18; H04B 1/00; H04B 1/04

(52) U.S. Cl. CPC H04B 1/18; H04B 1/0067; H04B 1/04

(57) ABSTRACT

An electronic device may wireless circuitry with first and second transmission lines. A signal combiner may couple the first and second transmission lines to a path. The combiner may include an output circuit coupled to the path, a first transistor that couples the first transmission line to a first input of the output circuit, and a second transistor that couples the second transmission line to a second input of the output circuit. The signal combiner may include a first capacitor that couples the first transmission line to the second input and may include a second capacitor that couples the second transmission line to the first input. If desired, resistors may be coupled in parallel with the capacitors. The output circuit may exhibit a high common mode rejection ratio. The output circuit, the capacitors, and/or the resistors may neutralize parasitic components of the transistors.

### FIELD

This disclosure relates generally to electronic devices, including electronic devices with wireless communications circuitry.

### BACKGROUND

Electronic devices are often provided with wireless communications capabilities. An electronic device with wireless communications capabilities has wireless circuitry with signal paths that convey radio-frequency signals. The wireless circuitry can include a signal combiner that combines radio-frequency signals on different signal paths together. It can be challenging to provide wireless circuitry with signal combiners that exhibit satisfactory levels of performance.

### SUMMARY

An electronic device may include wireless circuitry. The wireless circuitry may include at least first and second transmission lines that convey radio-frequency signals. The wireless circuitry may include a signal combiner that couples the first and second transmission lines to a signal path. The signal combiner may combine the radio-frequency signals into a combined signal on the signal path.

The signal combiner may include an output circuit coupled to the signal path. The signal combiner may include a first transistor that couples the first transmission line to a first input of the output circuit. The signal combiner may include a second transistor that couples the second transmission line to a second input of the output circuit. The transistors may be common gate or common source transistors. The output circuit may be coupled in series between the transistors and the signal path.

The signal combiner may include a first capacitor that couples the first transmission line to the second input of the output circuit. The signal combiner may include a second capacitor that couples the second transmission line to the first input of the output circuit. If desired, a first resistor may couple the first transmission line to the second input in parallel with the first capacitor and a second resistor may couple the second transmission line to the first input in parallel with the second capacitor. The output circuit may exhibit a high common mode rejection ratio. The output circuit, the capacitors, and/or the resistors may compensate for parasitic components of the transistors that otherwise limit isolation of the signal combiner.

An aspect of the disclosure provides a signal combiner having first and second input terminals and an output terminal. The signal combiner may include an output circuit coupled to the output terminal and having third and fourth input terminals. The signal combiner may include a first transistor having a first gate terminal coupled to the first input terminal, a first source-drain terminal coupled to a reference potential, and a second source-drain terminal coupled to the third input terminal. The signal combiner may include a second transistor having a second gate terminal coupled to the second input terminal, a third source-drain terminal coupled to the reference potential, and a fourth source-drain terminal coupled to the fourth input terminal. The signal combiner may include a first capacitor that couples the first gate terminal and the first input terminal to the fourth source-drain terminal and the fourth input terminal. The signal combiner may include a second capacitor that couples the second gate terminal and the second input terminal to the second source-drain terminal and the third input terminal.

An aspect of the disclosure provides a signal combiner having first and second input terminals and an output terminal. The signal combiner may include an output circuit coupled to the output terminal and having third and fourth input terminals. The signal combiner may include a first transistor having a first source-drain terminal coupled to the first input terminal and having a second source-drain terminal coupled to the third input terminal. The signal combiner may include a second transistor having a third source-drain terminal coupled to the second input terminal and having a fourth source-drain terminal coupled to the fourth input terminal. The signal combiner may include a first capacitor that couples the first source-drain terminal and the first input terminal to the fourth source-drain terminal and the fourth input terminal. The signal combiner may include a second capacitor that couples the third source-drain terminal and the second input terminal to the second source-drain terminal and the third input terminal.

An aspect of the disclosure provides wireless circuitry. The wireless circuitry can include a phased antenna array that includes a first antenna and a second antenna. The wireless circuitry can include a first transmission line coupled to the first antenna. The wireless circuitry can include a second transmission line coupled to the second antenna. The wireless circuitry can include a signal combiner that couples the first and second transmission lines to a signal path. The signal combiner can include an output circuit coupled to the signal path and having first and second input terminals. The signal combiner can include a first transistor coupled between the first transmission line and the first input terminal. The signal combiner can include a second transistor coupled between the second transmission line and the second input terminal. The signal combiner can include a first capacitor that couples the first transmission line to the second input terminal. The signal combiner can include a second capacitor that couples the second transmission line to the first input terminal.

### BRIEF DESCRIPTION OF THE DRAWINGS

FIG. 1 is a schematic diagram of an illustrative electronic device having wireless circuitry in accordance with some embodiments.

FIG. 2 is a schematic diagram of illustrative wireless circuitry in accordance with some embodiments.

FIG. 3 is a circuit diagram of illustrative wireless circuitry that includes a phased antenna array and an active signal combiner in accordance with some embodiments.

FIG. 4 is a circuit diagram of an illustrative active signal combiner that includes common source transistors in accordance with some embodiments.

FIG. 5 is a circuit diagram of an illustrative active signal combiner that includes common gate transistors in accordance with some embodiments.

FIG. 6 is a plot illustrating characteristics of an active signal combiner in accordance with some embodiments.

FIG. 7 is a circuit diagram of an illustrative output circuit for an active signal combiner in accordance with some embodiments.

FIG. 8 is a layout diagram of an illustrative transformer in an output circuit for an active signal combiner in accordance with some embodiments.

### DETAILED DESCRIPTION

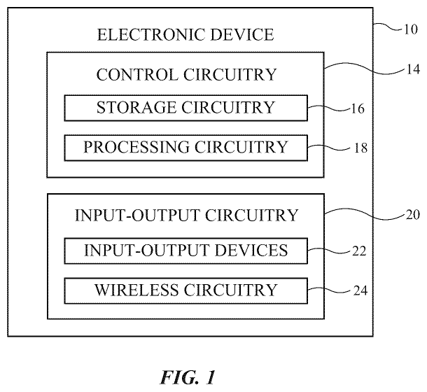

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, a helmet, or other equipment worn on a user's head (e.g., an augmented, virtual, or mixed reality head-mounted display device), or another wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the schematic diagram FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays, light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support wireless communications. Wireless circuitry 24 (sometimes referred to herein as wireless communications circuitry 24) may include one or more antennas. Wireless circuitry 24 may also include baseband processor circuitry, transceiver circuitry, amplifier circuitry, filter circuitry, switching circuitry, radio-frequency transmission lines, radio-frequency front end circuitry, and/or any other circuitry for transmitting and/or receiving radio-frequency signals using the antenna(s).

Wireless circuitry 24 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands between 10-100 GHz, sub-THz frequency bands between around 100 GHz and 10 THz (e.g., 6G bands), near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

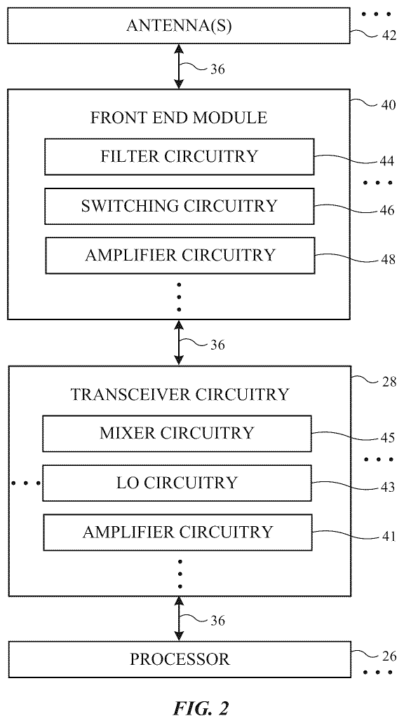

FIG. 2 is a diagram showing illustrative components within wireless circuitry 24. As shown in FIG. 2, wireless circuitry 24 may include one or more processors such as processor(s) 26, radio-frequency (RF) transceiver circuitry such as radio-frequency transceiver 28, radio-frequency front end circuitry such as radio-frequency front end module (FEM) 40, and antenna(s) 42. Processor(s) 26 may include baseband circuitry (e.g., one or more baseband processors), an application processor, a digital signal processor, a microcontroller, a microprocessor, a central processing unit (CPU), a programmable device, an a combination of these circuits, and/or one or more processors within processing circuitry 18 of FIG. 1. Processor(s) 26 may be configured to generate digital (transmit or baseband) signals. Processor(s) 26 may be coupled to transceiver 28 over path 34 (sometimes referred to as a baseband path). Transceiver 28 may be coupled to antenna 42 via radio-frequency transmission line path 36. If desired, one or more radio-frequency front end modules such as radio-frequency front end module 40 may be disposed along radio-frequency transmission line path 36 between transceiver 28 and antenna 42.

Wireless circuitry 24 may include one or more antennas such as antenna 42. Antenna 42 may be formed using any desired antenna structures. For example, antenna 42 may be an antenna with a resonating element that is formed from loop antenna structures, patch antenna structures, inverted-F antenna (IFA) structures, slot antenna structures, planar inverted-F antenna (PIFA) structures, helical antenna structures, monopole antennas, dipoles, dielectric resonator antenna (DRA) structures, waveguide antenna structures, bowtie antenna structures, hybrids of these designs, etc. If desired, two or more antennas 42 may be arranged into one or more phased antenna arrays (e.g., for conveying radio-frequency signals at millimeter wave frequencies). If desired, parasitic elements may be included in antenna 42 to adjust antenna performance. If desired, antenna 42 may be provided with a conductive cavity that backs the antenna resonating element of antenna 42 (e.g., antenna 42 may be a cavity-backed antenna such as a cavity-backed slot antenna).

In the example of FIG. 2, wireless circuitry 24 is illustrated as including only a single processor 26, a single transceiver 28, a single front end module 40, and a single antenna 42 for the sake of clarity. In general, wireless circuitry 24 may include any desired number of processors 26, any desired number of transceivers 28, any desired number of front end modules 40, and any desired number of antennas 42. Each processor 26 may be coupled to one or more transceiver 28 over respective paths 34. Each transceiver 28 may include a transmitter circuit configured to output uplink signals to antenna 42, may include a receiver circuit configured to receive downlink signals from antenna 42, and may be coupled to one or more antennas 42 over respective radio-frequency transmission line paths 36. Each radio-frequency transmission line path 36 may have a respective front end module 40 disposed thereon. If desired, two or more front end modules 40 may be disposed on the same radio-frequency transmission line path 36. If desired, one or more of the radio-frequency transmission line paths 36 in wireless circuitry 24 may be implemented without any front end module disposed thereon.

Front end module (FEM) 40 may include radio-frequency front end circuitry that operates on the radio-frequency signals conveyed (transmitted and/or received) over radio-frequency transmission line path 36. Front end module may, for example, include front end module (FEM) components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifiers and one or more low-noise amplifiers), impedance matching circuitry (e.g., circuitry that helps to match the impedance of antenna 42 to the impedance of radio-frequency transmission line path 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front end module components may be mounted to a common (shared) substrate such as a rigid printed circuit board substrate or flexible printed circuit substrate. If desired, the various front end module components may also be integrated into a single integrated circuit chip.

Filter circuitry 44, switching circuitry 46, amplifier circuitry 48, and other circuitry may be disposed along radio-frequency transmission line path 36, may be incorporated into FEM 40, and/or may be incorporated into antenna 42 (e.g., to support antenna tuning, to support operation in desired frequency bands, etc.). These components, sometimes referred to herein as antenna tuning components, may be adjusted (e.g., using control circuitry 14) to adjust the frequency response and wireless performance of antenna 42 over time.

Radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path such that is coupled to the positive antenna feed terminal on antenna 42. Radio-frequency transmission line path 36 may have a ground transmission line signal path that is coupled to the ground antenna feed terminal on antenna 42. This example is illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include one or more transmission lines that are used to route radio-frequency signals within device 10 (FIG. 1). Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 36 may be integrated into rigid and/or flexible printed circuit boards. In one suitable implementation, radio-frequency transmission line paths such as radio-frequency transmission line path 36 may also include transmission line conductors integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

Transceiver 28 may include wireless local area network transceiver circuitry that handles WLAN communications bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network transceiver circuitry that handles the 2.4 GHz Bluetooth® band or other WPAN communications bands, cellular telephone transceiver circuitry that handles cellular telephone bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands above 100 GHz, etc.), near-field communications (NFC) transceiver circuitry that handles near-field communications bands (e.g., at 13.56 MHz), satellite navigation receiver circuitry that handles satellite navigation bands (e.g., a GPS band from 1565 to 1610 MHz, a Global Navigation Satellite System (GLONASS) band, a BeiDou Navigation Satellite System (BDS) band, etc.), ultra-wideband (UWB) transceiver circuitry that handles communications using the IEEE 802.15.4 protocol and/or other ultra-wideband communications protocols, and/or any other desired radio-frequency transceiver circuitry for covering any other desired communications bands of interest.

The term “convey radio-frequency signals” as used herein means the transmission and/or reception of the radio-frequency signals (e.g., for performing unidirectional and/or bidirectional wireless communications with external wireless communications equipment). In performing wireless transmission, processor 26 may provide digital signals to transceiver 28 over path 34. Transceiver 28 may further include circuitry for converting the baseband signals received from processor 26 into corresponding intermediate frequency or radio-frequency signals. For example, transceiver 28 may include mixer circuitry 45 that up-converts (or modulates) the baseband signals to intermediate frequencies (e.g., as intermediate frequency (IF) signals), that up-converts the baseband signals to radio frequencies higher than the intermediate frequencies (e.g., as radio-frequency (RF) signals), and/or that up-converts IF signals to radio frequencies prior to transmission over antenna 42. Transceiver 28 may also include digital-to-analog converter (DAC) and/or analog-to-digital converter (ADC) circuitry that converts signals between digital and analog domains. Transceiver 28 may include amplifier circuitry 41 (e.g., one or more power amplifiers) that amplify the radio-frequency signals for transmission. Additionally or alternatively, one or more power amplifiers in amplifier circuitry 48 may amplify the radio-frequency signals for transmission. Transceiver 28 may include a transmitter that transmits the radio-frequency signals over antenna 42 via radio-frequency transmission line path 36 and front end module 40. Antenna 42 may transmit the radio-frequency signals to external wireless equipment by radiating the radio-frequency signals into free space (or into free space through a dielectric cover layer on device 10).

In performing wireless reception, antenna 42 may receive radio-frequency signals from external wireless equipment (e.g., from free space). The received radio-frequency signals may be conveyed to transceiver 28 via radio-frequency transmission line path 36 and front end module 40. One or more low noise amplifiers in amplifier circuitry 41 and/or amplifier circuitry 48 may amplify the received signals. Transceiver 28 may include circuitry for converting the received radio-frequency signals into corresponding intermediate frequency or baseband signals. For example, transceiver 28 may use mixer circuitry 45 to downconvert (or demodulate) the received radio-frequency signals to intermediate frequencies, to downconvert the received radio-frequency signals to baseband frequencies (e.g., as baseband signals or baseband data), and/or to downconvert IF signals to baseband frequencies prior to conveying the received signals to processor 26 over path 34. Mixer circuitry 45 can include local oscillator circuitry such as local oscillator (LO) circuitry 43. Local oscillator circuitry 43 can generate oscillator signals that mixer circuitry 45 uses to modulate transmit signals from baseband frequencies to radio frequencies and/or to demodulate received signals from radio frequencies to baseband frequencies.

Wireless circuitry 24 may include one or more signal combiners that combine signals propagating along two or more signal paths together. The signal combiners may include, for example, radio-frequency signal combiners that combine radio-frequency signals propagating along two or more radio-frequency transmission line paths 36 together. These signal combiners may be disposed on front end module 40, between front end module 40 and antenna(s) 42, on transceiver circuitry 28, or between front end module 40 and transceiver circuitry 28, as examples. In some implementations that are described herein as an example, wireless circuitry 24 may include a signal combiner that combines radio-frequency signals received by different antennas 42 of a phased antenna array together.

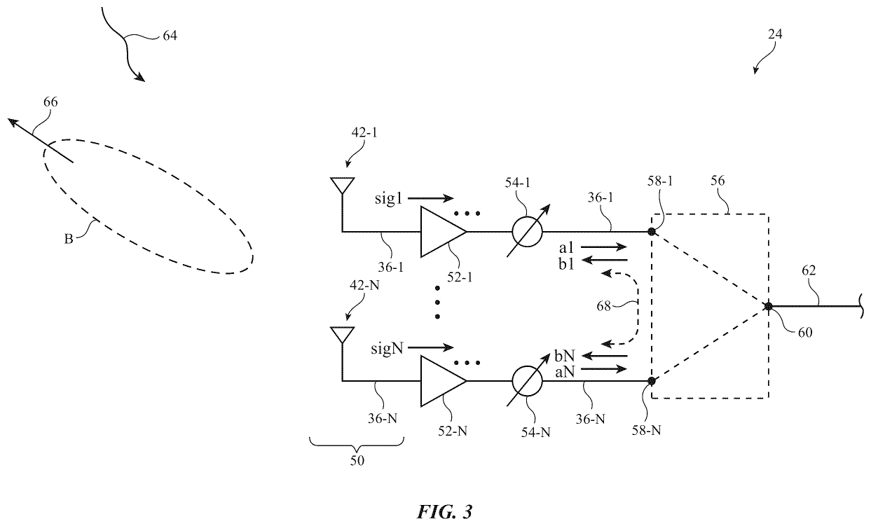

FIG. 3 is a circuit diagram showing one example of how wireless circuitry 24 may include a signal combiner 56 for combining radio-frequency signals received by different antennas of a phased antenna array 50 together. As shown in FIG. 3, phased antenna array 50 (sometimes referred to herein as array 50, antenna array 50, or array 50 of antennas 42) may include N antennas 42. N may be any desired integer greater than or equal to two. Each antenna 42 in phased antenna array 50 may be couple to a different respective radio-frequency transmission line path 36 (e.g., antenna 42-1 in phased antenna array 50 may be coupled to radio-frequency transmission line path 36-1, antenna 42-N in phased antenna array 50 may be coupled to radio-frequency transmission line path 36-N, etc.). Although antennas 42 are described herein as forming a phased antenna array, the antennas 42 in phased antenna array 50 may sometimes also be referred to as collectively forming a single phased array antenna (e.g., where antennas 42 form antenna elements of the phased array antenna).

The antennas 42 in phased antenna array 50 may be arranged in any desired number of rows and columns or in any other desired pattern (e.g., the antennas need not be arranged in a grid pattern having rows and columns). Each antenna 42 may be separated from one or more adjacent antennas 42 in phased antenna array 50 by a predetermined distance or phase relationship such as approximately half an effective wavelength of operation of the array. During signal transmission operations, radio-frequency transmission line paths 36 may be used to supply signals from transceiver circuitry (e.g., transceiver 28 of FIG. 2) to phased antenna array 50 for wireless transmission. During signal reception operations, radio-frequency transmission line paths 36 may be used to supply signals received at phased antenna array 50 (e.g., from external wireless equipment or transmitted signals that have been reflected off of external objects) to the transceiver circuitry.

The use of multiple antennas 42 in phased antenna array 50 allows beam forming/steering arrangements to be implemented by controlling the relative phases and magnitudes (amplitudes) of the radio-frequency signals conveyed by the antennas. In the example of FIG. 3, one or more amplifiers 52 (e.g., low noise amplifiers (LNAs)) and adjustable phase shifters 54 may be disposed on radio-frequency transmission line paths 36 (e.g., one or more amplifiers 52-1 and phase shifter 54-1 may be disposed on radio-frequency transmission line path 36-1, one or more amplifiers 52-N and phase shifter 54-N may be disposed on radio-frequency transmission line path 36-N, etc.). The example of FIG. 3 illustrates only the receive paths for phased antenna array 50 (e.g., containing circuitry for receiving radio-frequency signals via phased antenna array 50) for the sake of simplicity. If desired, phased antenna array 50 may also include transmit paths coupled to each antenna 42, where the transmit paths include power amplifiers and phase shifters for performing beamforming.

Amplifiers 52 may adjust the magnitude of the radio-frequency signals on radio-frequency transmission line paths 36. Phase shifters 54 may adjust (shift) the phase of the radio-frequency signals on radio-frequency transmission line paths 36. Phase shifters 54 and amplifiers 52 are sometimes also referred to collectively herein as phase and magnitude controllers, beam steering circuitry, or beam forming circuitry for phased antenna array 50 (e.g., beam steering/forming circuitry that steers/forms the beam of radio-frequency signals transmitted and/or received by phased antenna array 50).

Amplifiers 52 and phase shifters 54 may adjust the relative phases and/or magnitudes of radio-frequency signals that are received by phased antenna array 50. The term “beam” or “signal beam” is used herein to collectively refer to wireless signals that are transmitted and/or received by phased antenna array 50 in a particular direction. Each beam may exhibit a peak gain that is oriented in a respective beam pointing direction at a corresponding beam pointing angle (e.g., based on constructive and destructive interference from the combination of signals from each antenna in the phased antenna array). Different sets of phase and magnitude settings for amplifiers 52 and phase shifters 54 may configure phased antenna array 50 to form different beams in different beam pointing directions.

If, for example, amplifiers 52 and phase shifters 54 are adjusted to produce a first set of phases and/or magnitudes, the signals will form a beam B oriented in a first direction. If, however, amplifiers 52 and phase shifters 54 are adjusted to produce a second set of phases and/or magnitudes, the signals will form a beam B oriented in a second direction. Amplifiers 52 and phase shifters 54 may receive control signals (not shown) that control the phase shifters and amplifiers to form a signal beam in a desired direction.

In the example of FIG. 3, beam steering is shown as being performed over a single degree of freedom for the sake of simplicity (e.g., towards the top and bottom of the page of FIG. 3). However, in practice, the beam may be steered over two or more degrees of freedom. Phased antenna array 50 may have a corresponding field of view over which beam steering can be performed (e.g., in a hemisphere or a segment of a hemisphere over the phased antenna array).

During signal reception, radio-frequency signals 64 may be incident upon phased antenna array 50. Each antenna 42 may receive radio-frequency signals 64 (e.g., over a slightly different path length) and may pass the received radio-frequency signals onto radio-frequency transmission line paths 36 as a different respective radio-frequency signal sig (e.g., antenna 42-1 may pass radio-frequency signal sig1 onto radio-frequency transmission line path 36-1, antenna 42-N may pass radio-frequency signal sigN onto radio-frequency transmission line path 36-N, etc.). Each radio-frequency signal sig may be phase shifted with respect to the other radio-frequency signals sig depending on the angle-of-arrival of radio-frequency signals 64 and the predetermined spatial/phase relationship between the antennas 42 in phased antenna array 50.

Wireless circuitry 24 may include a radio-frequency signal combiner or adder such as signal combiner 56. Signal combiner 56 may have at least N input terminals (ports) 58 that are each coupled to a respective radio-frequency transmission line path 36 (e.g., signal combiner 56 may have a first input terminal 58-1 coupled to radio-frequency transmission line path 36-1, may have an Nth input terminal 58-N coupled to radio-frequency transmission line path 36-N, etc.). Signal combiner 56 may have an output terminal (port) 60 that is communicatively coupled to transceiver 28 (FIG. 2) over signal path 62 (e.g., a radio-frequency transmission line path). If desired, wireless circuitry 24 may include additional circuitry on radio-frequency transmission line paths 36 (e.g., signal attenuator circuitry, filter circuitry, switching circuitry, additional amplifier circuitry, mixer circuitry, signal couplers, etc.), but the additional circuitry has been omitted from FIG. 3 for the sake of clarity.

Each amplifier 52 may control (adjust) the magnitude of the radio-frequency signal sig received by its corresponding antenna 42. Each phase shifter 54 may control (adjust) the phase of the radio-frequency signal sig received by its corresponding antenna 42. Control signals may control, set, and/or adjust (tune) the gain of amplifiers 52 and the phase shifts of phase shifters 54 over time. The respective gains of amplifiers 52 and the respective phase shifts of phase shifters 54 across phased antenna array 50 may be selected to form a corresponding signal beam B for phased antenna array 50 that is oriented in a selected beam pointing direction 66 (e.g., in the direction of external communications equipment that is transmitting the received signal) and may be adjusted over time to steer or move signal beam B to other beam pointing directions. Phased antenna array 50 may receive the signal from beam pointing direction 66 using signal beam B.

Signal combiner 56 may receive the radio-frequency signals sig that are amplified by amplifiers 52 and phase shifted by phase shifters 54 at its input terminals 58. Signal combiner 56 may combine (add) the radio-frequency signals sig received at each of its input terminals 58 together at/onto its output terminal 60 (e.g., producing a combined or added radio-frequency signal on signal path 62 that is formed from the combination of the N radio-frequency signals sig received over radio-frequency transmission line paths 36). The gains of amplifiers 52 and the phase shifts of phase shifters 54 may be selected to maximize the magnitude of the combined signal output onto signal path 62. Put differently, amplifiers 52 and phase shifters 54 may be adjusted until the N radio-frequency signals sig received over radio-frequency transmission line paths 36 are coherently added together by signal combiner 56, which may occur when beam B has a beam pointing direction 66 oriented in the direction of incidence of radio-frequency signals 64 given the predetermined phase/spatial relationship between the antennas 42 in phased antenna array 50.

The power of the combined signal on signal path 62 is much higher than the power of any single radio-frequency signal sig received by a single antenna 42, which helps to mitigate signal attenuation during propagation of radio-frequency signal 64 towards device 10 even at high frequencies. Signal combiner 56 is sometimes also referred to herein as power combiner 56. FIG. 3 illustrates a simplest case in which N=2 and signal combiner 56 is a 2:1 signal combiner that combines two signals (e.g., radio-frequency signals sig1 and sigN) together on signal path 62. This is illustrative and, in general, N may be any desired even integer greater than or equal to two and signal combiner 56 may be an N:1 signal combiner.

The power of radio-frequency signal sig1 as incident upon input terminal 58-1 may be characterized by a coefficient a1. The power of radio-frequency signal sigN as incident upon input terminal 58-N may be characterized by a coefficient aN. An impedance mismatch between signal combiner 56 and radio-frequency transmission line path 36-1, an impedance mismatch between signal combiner 56 and radio-frequency transmission line path 36-2, or copuling (finite isolation) between signal paths may cause some of the radio-frequency signal sig1 incident upon input terminals 58-1 and/or 58-2 to reflect back with power characterized by coefficients b1 and bN.

Coefficient b1 may be given by the equation b1=S11*a1+S21*a2 and coefficient bN may be given by the equation bN=S22*a2+S21*a1, where S11, S22, and S21 are scattering parameters (sometimes also referred to as S-parameters). If care is not taken, signals coupled from other paths due to finite isolation of the signal combiner can pull phase from the phase shifters, which can introduce phase errors to the received radio-frequency signals.

Signal combiner 56 may include any desired signal or power combiner circuitry. In some situations, the signal combiner is a passive signal combiner that includes one or more resistive components such as a Wilkinson combiner. However, while Wilkinson combiners exhibit a relatively high level of impedance matching and a relatively high level of isolation between input terminals, the resistive components in Wilkinson combiners introduce a non-zero loss of at least 3 dB to the combined signal output by the combiner. This loss, when applied in large array systems, can compromise noise performance and offset the signal-to-noise ratio (SNR) benefit otherwise achievable using beamforming techniques. For example, when the phased antenna array includes eight antennas, three Wilkinson combiners are used to combine the signals received by the eight antennas and each Wilkinson combiner will introduce at least 3 dB of insertion loss to the received signals, producing at least a 9 dB loss in the combined signal.

In other situations, the signal combiner may be an active signal combiner to help prevent this type of signal loss. Active combiners contribute power gain to the combined signal, which can help to minimize noise in the combined signal. Active combiners may include common source parallel combiners, common gate parallel combiners, common source series combiners, and common gate series combiners, as examples. However, if care is not taken, active combiners such as these can exhibit insufficient isolation between input terminals due to parasitic capacitances and/or resistances of transistors in the active combiners. For example, common source combiners can exhibit insufficient reverse isolation due to the presence of gate-to-drain parasitic capacitances of the transistors and common gate combiners can suffer from issues due to the presence of drain-to-source capacitances and resistances. These parasitic components not only degrade isolation, thereby impacting phase shifting, but can also jeopardize amplifier stability, input matching, and the transfer function across various excitation conditions.

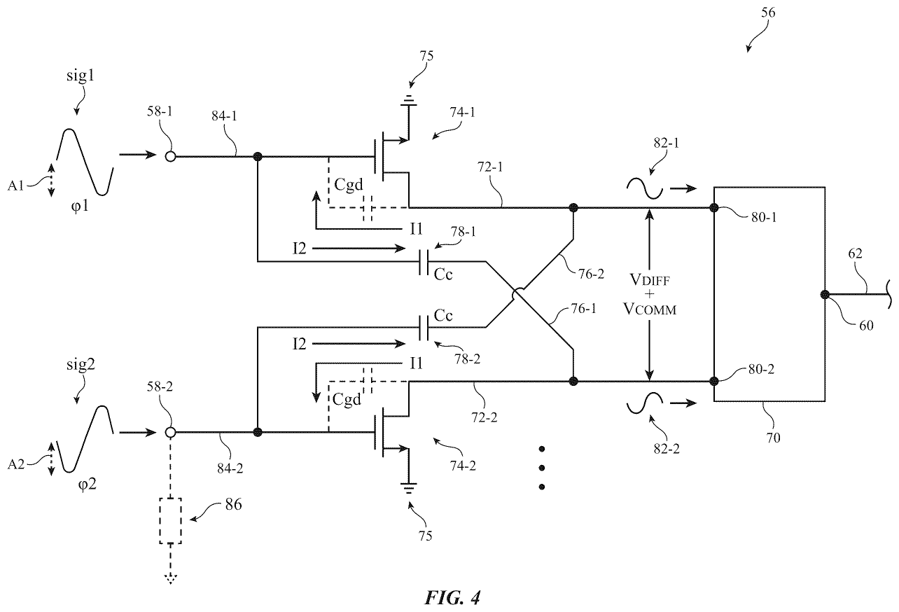

To help mitigate these issues, signal combiner 56 may be an active common source or common gate series combiner that includes N transistors coupled between respective input terminals 58 and an output circuit coupled to output terminal 60 and that includes cross coupled parasitic mitigation circuitry around the transistors. FIG. 4 is a circuit diagram of signal combiner 56 in implementations where signal combiner 56 is an active common source series combiner having cross coupled parasitic mitigation circuitry. The example of FIG. 4 illustrates a simplest case in which N=2. This is non-limiting and, if desired, the circuitry shown in FIG. 4 may be scaled for implementations in which N is any desired even integer greater than 2.

As shown in FIG. 4, signal combiner 56 may include a set of N transistors 74 such as transistors 74-1 and 74-2 coupled between respective input terminals 58 and an output circuit such as output circuit 70 (sometimes also referred to herein as output circuitry 70 or output network 70). Output circuit 70 may have N input terminals (ports) 80 (e.g., at least a first input terminal 80-1 and a second input terminal 80-2). Output circuit 70 may couple each of its input terminals 80 to the output terminal 60 of signal combiner 56.

The terms “source” and “drain” terminals used to refer to current-conveying terminals in a transistor may be used interchangeably and are sometimes referred to as “source-drain” terminals. Thus, the drain terminal of a transistor 74 can sometimes be referred to as a first source-drain terminal, and the source terminal of a transistor 74 can be referred to as a second source-drain terminal (or vice versa).

Transistor 74-1 may have a first source-drain terminal coupled to a reference voltage such as ground 75. Transistor 74-1 may have a second source-drain terminal coupled to signal line 72-1. Signal line 72-1 may couple the second source-drain terminal of transistor 74-1 to input terminal 80-1 of output circuit 70. A signal line 84-1 may couple the gate terminal of transistor 74-1 to input terminal 58-1 of signal combiner 56. Signal lines 72-1 and 84-1 are sometimes also referred to herein as different respective portions of the same signal line coupling input terminal 58-1 to input terminal 80-1.

Transistor 74-2 may have a first source-drain terminal coupled to a reference voltage such as ground 75. Transistor 74-2 may have a second source-drain terminal coupled to signal line 72-2. Signal line 72-2 may couple the second source-drain terminal of transistor 74-2 to input terminal 80-2 of output circuit 70. A signal line 84-2 may couple the gate terminal of transistor 74-2 to input terminal 58-2 of signal combiner 56. When coupled in this way, transistors 74-1 and 74-2 may form common source transistors (e.g., having first source-drain terminals coupled to the same reference potential and having gate terminals driven by signals received by signal combiner 56 over input terminals 58). Signal lines 72-2 and 84-2 are sometimes also referred to herein as different respective portions of the same signal line coupling input terminal 58-1 to input terminal 80-1.

Output circuit 70 may include any desired output circuitry that couples signal lines 72-1 and 72-2 to output terminal 60 and signal path 62. If desired, output circuit 70 may be configured to exhibit a relatively high common mode rejection ratio (CMRR). Output circuit 70 may include, for example, a high CMRR transformer, one or more inductors, a balun, impedance matching circuitry, and/or other circuitry.

Signal combiner 56 may receive radio-frequency signal sig1 with a corresponding amplitude A1 (e.g., as provided by amplifier 52-1 and/or other circuitry on radio-frequency transmission line path 36-1 of FIG. 3) and a corresponding phase φ1 (e.g., as provided by phase shifter 54-1 and/or other circuitry on radio-frequency transmission line path 36-1 of FIG. 3) at input terminal 58-1. At the same time, signal combiner 56 may receive radio-frequency signal sig2 with a corresponding amplitude A2 (e.g., as provided by amplifier 52-N and/or other circuitry on radio-frequency transmission line path 36-N of FIG. 3) and a corresponding phase φ2 (e.g., as provided by phase shifter 54-N and/or other circuitry on radio-frequency transmission line path 36-N of FIG. 3) at input terminal 58-2. The signals combined by signal combiner 56 may be of opposite phase. Put differently, radio-frequency signals sig1 and sig2 may be 180 degrees out of phase with respect to each other (e.g., phase shifters 54-N and 54-1 may phase shift radio-frequency signals sig2 and sig1, respectively, such that phase φ2 is equal to phase φ1 plus 180 degrees at input terminals 58-1 and 58-2).

Radio-frequency signal sig1 may drive the gate terminal of transistor 74-1 over signal line 84-1, causing corresponding current to flow between signal line 72-1 and ground 75 through the source-drain terminals of transistor 74-1. This may serve, for example, amplify or impart a gain to radio-frequency signal sig1 to produce a corresponding radio-frequency signal (waveform) 82-1 that is received at input terminal 80-1 of output circuit 70. At the same time, radio-frequency signal sig2 may drive the gate terminal of transistor 74-2 over signal line 84-2, causing corresponding current to flow between signal line 72-2 and ground 75 through the source-drain terminals of transistor 74-2. This may serve, for example, amplify or impart a gain to radio-frequency signal sig2 to produce a corresponding radio-frequency signal (waveform) 82-2 that is received at input terminal 80-2 of output circuit 70. Output circuit 70 may combine radio-frequency signals 82-1 and 82-2 together at its output terminal 60 and onto signal path 62.

In practice, transistor 74-1 exhibits a parasitic capacitance such as parasitic gate-drain capacitance Cgd between its gate terminal and its second source-drain terminal. Transistor 74-2 also exhibits parasitic gate-drain capacitance Cgd between its gate terminal and its second source-drain terminal. If care is not taken, parasitic capacitance Cgd causes a non-zero current I1 to flow back from signal line 72-1 onto signal line 84-1 through transistor 74-1 and causes a non-zero current I1 to flow back from signal line 72-2 onto signal line 84-2 through transistor 74-2, limiting the isolation of signal combiner 56.

To help mitigate these issues, signal combiner 56 may include cross-coupled parasitic mitigation circuitry coupled around transistors 74-1 and 74-2. For example, signal combiner 56 may include a first cross-coupled line 76-1 that couples signal line 84-1 to signal line 72-2 and may include a second cross-coupled line 76-2 that couples signal 84-2 to signal line 72-1. Cross-coupled lines 76 are sometimes also referred to herein as cross-coupled paths 76. Signal combiner 56 may include a first capacitor 78-1 disposed on cross-coupled line 76-1 and may include a second capacitor 78-2 disposed on cross-coupled line 76-2.

Capacitor 78-1 may, for example, have a first capacitor electrode coupled to signal line 84-1 and thus to the gate terminal of transistor 74-1 and input terminal 58-1. Capacitor 78-1 may have a second capacitor electrode coupled to signal line 72-2 and thus to the second source-drain terminal of transistor 74-2 and input terminal 80-2 of output circuit 70. At the same time, capacitor 78-2 may have a first capacitor electrode coupled to signal line 84-2 and thus to the gate terminal of transistor 74-2 and input terminal 58-2. Capacitor 78-2 may have a second capacitor electrode coupled to signal line 72-1 and thus to the second source-drain terminal of transistor 74-1 and input terminal 80-1 of output circuit 70. Put differently, capacitors 78-1 and 78-2 may be cross-coupled between input terminals of signal combiner 56 and around transistors 74-1 and 74-2.

When input terminals 58-1 and 58-2 are driven by opposite phase radio-frequency signals sig1 and sig 2, respectively, radio-frequency signal 82-1 is produced on signal line 72-1 and radio-frequency signal 82-2 is produced on signal line 72-1 with both a differential mode component and a common mode component (e.g., the voltage between signal lines 72-1 and 72-2 may be given by the sum of a differential voltage V_{DIFF} and a common mode voltage V_{COMM}). The amplitude of the common mode component may be substantially smaller than the amplitude of the differential mode component. On the other hand, the differential mode component of signal 82-1 is 180 degrees out of phase with respect to the differential mode component of signal 82-2. This may serve to draw an additional current I2 from signal line 84-1 onto signal line 72-2 through cross-coupled line 76-1 and capacitor 78-1, while also drawing an additional current I2 from signal line 84-2 onto signal line 72-1 through cross-coupled line 76-2 and capacitor 78-2.

Capacitors 78-1 and 78-2 may each exhibit a capacitance Cc that cancels out or equalizes the parasitic gate-drain capacitance Cgd of transistors 74-1 and 74-2 (e.g., capacitance Cc may be equal to parasitic gate-drain capacitance Cgd). The current I2 flowing through cross-coupled line 76-1 and capacitor 78-1 may be equal and opposite to the current I1 flowing from signal line 72-1 onto signal line 84-1 through transistor 74-1, effectively canceling out the current I1 through transistor 74-1. At the same time, the current I2 flowing through cross-coupled line 76-2 and capacitor 78-2 may be equal and opposite to the current I1 flowing from signal line 72-2 onto signal line 84-2 through transistor 74-2, effectively canceling out the current I1 through transistor 74-2.

Output circuit 70 may exhibit a relatively high amount of common mode rejection (e.g., a relatively high CMRR) to help ensure that the drain swing of transistors 74 predominantly contains the differential mode component of radio-frequency signals 82-1 and 82-2, with minimal presence of common mode signal irrespective of the input excitation of signal combiner 56. Signal combiner 56 may, for example, exhibit a CMRR (e.g., given by V_{DIFF}/V_{COMM}) that is up to 40 dB or higher. This may, for example, be evidenced by the symmetric nature of the drain voltages observed between signal lines 72-1 and 72-2.

In this way, cross-coupled lines 76 and capacitors 78 may cancel out, equalize, neutralize, or compensate for the parasitic gate-drain capacitance Cgd of transistors 74, which may serve to maximize the isolation of signal combiner 56. For example, signal combiner 56 may neutralize the effects of the parasitic gate-drain capacitance Cgd of transistors 74 when input terminals 58 are driven using a balanced excitation (e.g., where amplitude A1 equals amplitude A2 and phase φ1 is 180 degrees from phase φ2), when input terminals 58 are driven using an imbalanced excitation (e.g., where amplitude A1 is different than amplitude A2 and phase φ1 is 180 degrees from phase φ2), and when input terminals 58 are driven using an imbalanced excitation and configuration (e.g., where only input terminal 58-1 receives a radio-frequency signal while input terminal 58-2 is terminated by termination 86, causing transistor 74-2 and signal line 72-2 to be turned off, disabled, or inactive). This may also serve to maintain input matching for signal combiner 56 and to provide signal combiner 56 with a transfer function that is constant regardless of excitation configuration.

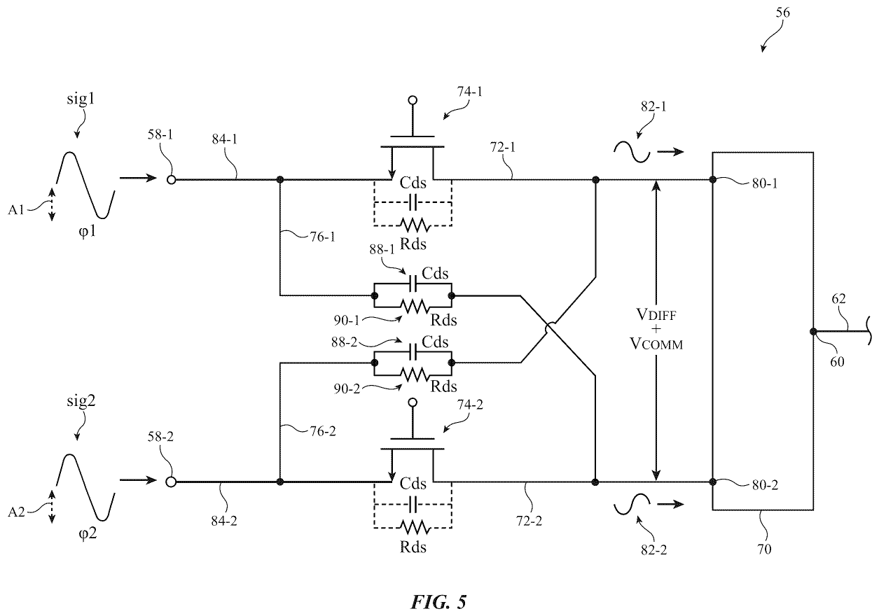

When implemented in this way, signal combiner 56 may form a current combiner for radio-frequency signals sig1 and sig2. The example of FIG. 4 in which signal combiner 56 is an active common source series combiner having cross coupled parasitic mitigation circuitry is illustrative and non-limiting. FIG. 5 shows another example in which signal combiner 56 is an active common gate series combiner having cross coupled parasitic mitigation circuitry. When implemented in this way, signal combiner 56 may form a voltage combiner for radio-frequency signals sig1 and sig2.

As shown in FIG. 5, the first source-drain terminal of transistor 74-1 may be coupled to input terminal 58-1 of signal combiner 56 over signal line 84-1 and the second source-drain terminal of transistor 74-1 may be coupled to input terminal 80-1 of output circuit 70 over signal line 72-1. Put differently, the source-drain terminals of transistor 74-1 may be coupled in series along a signal line or signal path coupling input terminal 58-1 of signal combiner 56 to input terminal 80-1 of output circuit 70.

At the same time, the first source-drain terminal of transistor 74-2 may be coupled to input terminal 58-2 of signal combiner 56 over signal line 84-2 and the second source-drain terminal of transistor 74-2 may be coupled to input terminal 80-2 of output circuit 70 over signal line 72-2. Put differently, the source-drain terminals of transistor 74-2 may be coupled in series along a signal line or signal path coupling input terminal 58-2 of signal combiner 56 to input terminal 80-2 of output circuit 70. The gate terminals of transistors 74-1 and 74-2 may be driven using a common gate voltage. When coupled in this way, transistors 74-1 and 74-2 may form common gate transistors coupled in series between output circuit 70 and respective input terminals 58.

Common gate transistors such as transistors 74-1 and 74-2 may exhibit a parasitic capacitance such as parasitic drain-source capacitance Cds and may exhibit a parasitic resistance such as parasitic drain-source resistance Rds between their first and second source-drain terminals. If left unmitigated, these parasitic components can cause non-zero current (see, e.g., current I1 of FIG. 4) to flow back from signal lines 72 onto signal lines 84 through transistors 74. To mitigate these parasitic components, cross-coupled line 76-1 may couple signal line 84-1, the first source-drain terminal of transistor 74-1, and input terminal 58-1 to signal line 72-2, the second source-drain terminal of transistor 74-2, and input terminal 80-2 of output circuit 70. Similarly, cross-coupled line 76-2 may couple signal line 84-2, the first source-drain terminal of transistor 74-2, and input terminal 58-2 to signal line 72-1, the second source-drain terminal of transistor 74-1, and input terminal 80-1 of output circuit 70.

A capacitor 88-1 having a capacitance equal to parasitic drain-source capacitance Cds and a resistor 90-1 having a resistance equal to parasitic drain-source resistance Rds may be coupled in parallel on cross-coupled line 76-1. Similarly, a capacitor 88-2 having a capacitance equal to parasitic drain-source capacitance Cds and a resistor 90-2 having a resistance equal to parasitic drain-source resistance Rds may be coupled in parallel on cross-coupled line 76-2. The differential mode component of radio-frequency signal 82-1 on signal line 72-1 and the differential mode component of radio-frequency signal 82-2 on signal line 72-2 may cause additional current (see, e.g., current I2 of FIG. 4) to flow from signal line 84-1 onto signal line 72-2 through cross-coupled line 76-1, resistor 90-1, and capacitor 88-1 to cancel out current flowing through the parasitic drain-source capacitance Cds and the parasitic drain-source resistance Rds of transistor 74-1. At the same time, the differential mode component of radio-frequency signal 82- on signal line 72-1 and the differential mode component of radio-frequency signal 82-2 on signal line 72-2 may cause additional current (see, e.g., current I2 of FIG. 4) to flow from signal line 84-2 onto signal line 72-1 through cross-coupled line 76-2, resistor 90-2, and capacitor 88-2 to cancel out current flowing through the parasitic drain-source capacitance Cds and the parasitic drain-source resistance Rds of transistor 74-2.

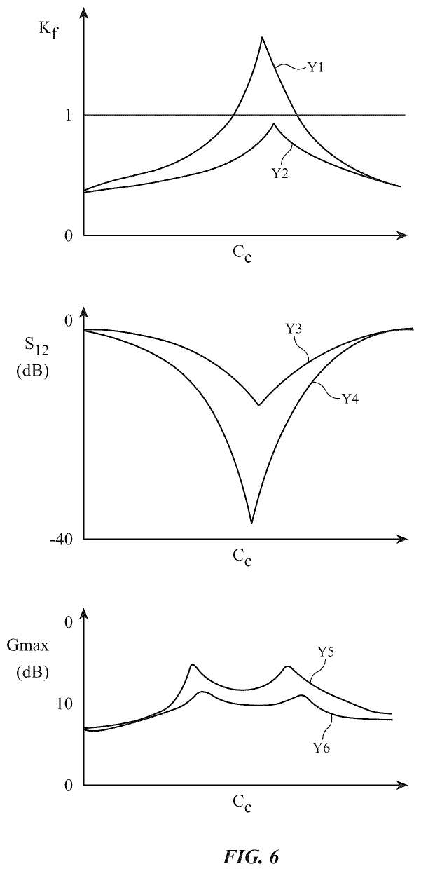

FIG. 6 includes plots showing how cross-coupled capacitors 78 and high CMRR rejection by output circuitry 70 may help improve the performance of signal combiner 56 under a single signal excitation on input terminal 58-1 while input terminal 58-2 is terminated with a 50 Ohm load 86 (FIG. 4). Curve Y1 plots stability factor k_{f} as a function of the capacitance CC of capacitors 78 under a high CMRR load. Curve Y2 plots stability factor k_{f} as a function of the capacitance CC of capacitors 78 under a low CMRR load. Curve Y4 plots S12 (coupling from the first port to the second port) under the high CMRR load. Curve Y3 plots S12 under the low CMRR load. Curve Y5 plots maximum available gain Gₘₐₓ under the high CMRR load. Curve Y6 plots maximum available Gₘₐₓ under the low CMRR load. As shown by curves Y1-Y6, the active signal combiner is not unconditional stable (k_{f}<1) without cross-coupled capacitances CC=0 and can exhibit poor S12 and Gₘₐₓ. When capacitors 78 are tuned to perfectly cancel out the corresponding parasitic capacitances such that capacitance CC=Cgd, the signal combiner exhibits boosted stability, port-to-port isolation, and maximum available gain Gₘₐₓ. However, the magnitude of improvement may depend on the load CMRR characteristic. A poorly selected CMRR transformer load may not benefit fully from parasitic capacitance cancelation and may cause phase/amplitude imbalance and deteriorated performance.

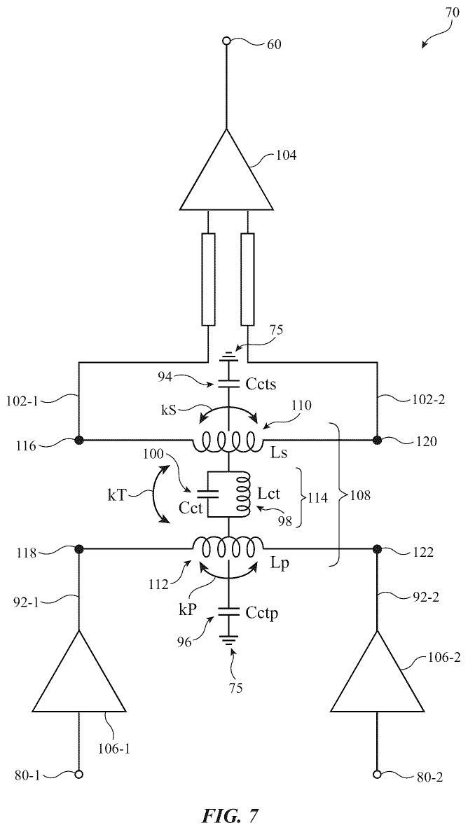

In general, output circuit 70 may include any desired circuit components that exhibit a relatively high CMRR. FIG. 7 shows one example of an output circuit 70 of signal combiner 56 in which output circuit 70 includes a high CMRR transformer such as transformer 108. As shown in FIG. 7, output circuit 70 may include a first signal line 92-1 coupled to input terminal 80-1 and a second signal line 92-2 coupled to signal terminal 80-2. Transformer 108 may include a first (primary) winding 112 having inductance Lp and a second (secondary) winding 110 that has an inductance Ls and that is electromagnetically coupled to primary winding 112 with a corresponding coupling coefficient kT.

Primary winding 112 may extend from a first terminal 118 to an opposing second terminal 122 (e.g., between first and second terminals of transformer 108). Terminal 118 may be coupled to signal line 92-1. Terminal 122 may be coupled to signal line 92-2. Secondary winding 110 may extend from a first terminal 116 to an opposing second terminal 120 (e.g., between third and fourth terminals of transformer 108). Terminal 116 may be coupled to signal line 102-1. Terminal 120 may be coupled to signal line 102-2. Output circuit 70 may include an amplifier 104 (e.g., a cascode amplifier) having a first input coupled to signal line 102-1, a second input coupled to signal line 102-2, and an output coupled to the output terminal 60 of output circuit 70 and thus signal combiner 56 (FIGS. 4 and 5). If desired, output circuit 70 may also include an amplifier 106-1 (e.g., a first common source amplifier) disposed on signal line 92-1 and an amplifier 106-2 (e.g., a second common source amplifier) disposed on signal line 92-2.

Primary winding 112 may have a center tap terminal, contact, or conductor coupled to ground 75 by a center tap capacitor 96 having capacitance C_{CTP}. Secondary winding 110 may have a center tap terminal or a center tap terminal, contact, or conductor coupled to ground 75 by a center tap capacitor 94 having capacitance C_{CTS}. The center tap of primary winding 112 may also be coupled to the center tap of secondary winding 110 by a resonant circuit such as tank 114. Tank 114 may include a center tap capacitor 100 having capacitance C_{CT} and a center tap inductor 98 having inductance L_{CT} coupled in parallel between the center taps of windings 110 and 112.

Output circuit 70 may exhibit high CMRR at primary winding 112 and may exhibit low phase and amplitude error at secondary winding 110. Primary winding 112 may also exhibit a relatively high coupling coefficient kP (e.g., across its center tap) and secondary winding 110 may also exhibit a relatively high coupling coefficient kS (e.g., across its center tap) to form a relatively low common mode impedance over a large bandwidth. Secondary winding 110 and primary winding 112 may each have, for example, an even number of turns.

The capacitance C_{CTP} of capacitor 96 and the capacitance C_{CTS} of capacitor 94 may be selected to resonate with a common mode inductance at a center frequency ω. Capacitance C_{CTP} may, for example, be given by the equation C_{CTP}=1/(ω²*Lp*(1−kP)/2. Capacitance C_{CTS} may, for example, be given by the equation C_{CTS}=1/(ω²*Ls*(1−kS)/2. The capacitance C_{CT} of capacitor 100 and the inductance L_{CT} of inductor 98 may be selected to configure tank circuit 114 to act as a choke at center frequency ω, which may help to suppress the common mode signal component from the center tap of primary winding 112. The example of FIG. 7 is illustrative and, in general, output circuit 70 may include any desired high CMRR circuit components (e.g., transformers, amplifiers, inductors, etc.).

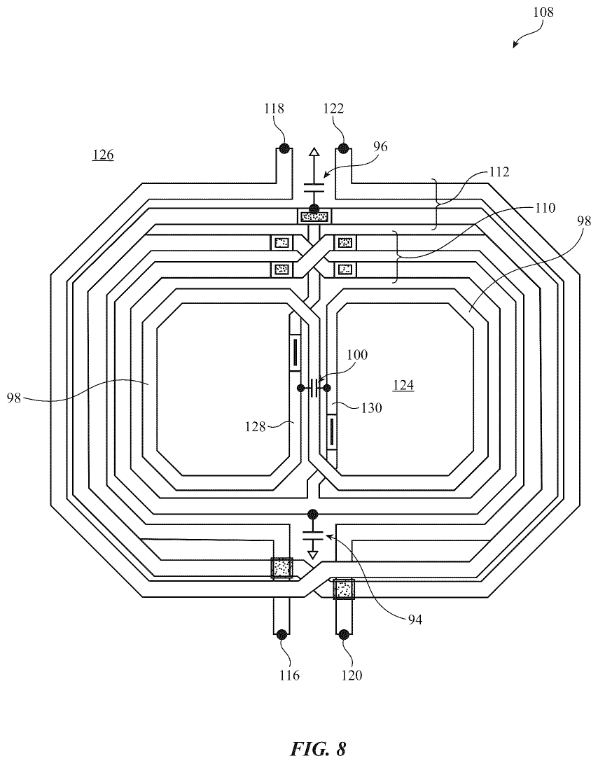

FIG. 8 is a layout diagram showing one example of how transformer 108 of FIG. 7 may be disposed on any underlying substrate 126 (e.g., a dielectric substrate such as a printed circuit board, a semiconductor substrate, etc.). As shown in FIG. 8, center tap inductor 98 may be formed from conductive traces extending around a central opening 124 (e.g., in a figure-eight layout). Center tap capacitor 100 may be coupled between segments 128 and 130 of center tap inductor 98 if desired. Alternatively, center tap capacitor 100 may be a distributed capacitance formed between segments 128 and 130. The length of center tap inductor 98 may be selected to impart center tap inductor 98 with a desired inductance L_{CT}.

Secondary winding 110 may wrap, turn, or coil an even number of times around center tap inductor 98 between terminals 116 and 120 of transformer 108. Primary winding 112 may wrap, turn, or coil an even number of times around secondary winding 110 between terminals 118 and 112 of transformer 108. Capacitor 94 may couple a center tap of secondary winding 110 to ground. Capacitor 96 may couple a center tap of primary winding 112 to ground. Secondary winding 110 and primary winding 112 may each include two turns, for example, to help maximize coupling between the coils for small common mode inductance (e.g., less than 56 pH on both the primary and secondary coil sides across a frequency band of operation of transformer 108). The CMRR of transformer 108 may be maximized via resonance of capacitors 94 and 96 with common mode inductance, which may cause the neutralization components in signal combiner 56 (e.g., capacitors 78 of FIG. 4 or capacitors 88 and resistors 90 of FIG. 5) to cancel out parasitic components of transistors 74 even under asymmetric driving/biasing conditions.

The example of FIG. 8 is illustrative and non-limiting. In general, transformer 108 may have other layouts. The choke formed from tank circuit 140 may serve to substantially increase the CMRR of output circuit 70 at the side of secondary winding 110 (e.g., by as high as 10-15 dB or more). Tank circuit 114 may also serve to slightly decrease the phase imbalance of output circuit 70 at the side of primary winding 112 and may serve to substantially decrease the phase imbalance of output circuit 70 at the side of secondary winding 110 (e.g., by as high as 11 degrees or higher). Tank circuit 114 may further serve to slightly decrease the amplitude imbalance of output circuit 70 at the side of primary winding 112 and may serve to substantially decrease the amplitude imbalance of output circuit 70 at the side of secondary winding 110 (e.g., by 0.6 dB or more).

Transformer 108 may operate over any desired frequency band. Signal combiner 56 may combine radio-frequency signals received by a phased antenna array or any other desired radio-frequency signals provided by any desired signal sources within device 10 or external to device 10. Signal combiner 56 may combine signals together at lower frequencies if desired (e.g., signal combiner 56 need not combine radio-frequency signals). Signal combiner 56 is sometimes also referred to herein as active signal combiner 56, radio-frequency signal combiner 56, active radio-frequency signal combiner 56, signal adder 56, active signal adder 56, or radio-frequency signal adder 56.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is illustrative and various modifications can be made to the described embodiments. The foregoing embodiments may be implemented individually or in any combination.

What is claimed is:

1. A signal combiner having first and second input terminals and an output terminal, comprising:
an output circuit coupled to the output terminal and having third and fourth input terminals;
a first transistor having a first gate terminal coupled to the first input terminal, a first source-drain terminal coupled to a reference potential, and a second source-drain terminal coupled to the third input terminal;
a second transistor having a second gate terminal coupled to the second input terminal, a third source-drain terminal coupled to the reference potential, and a fourth source-drain terminal coupled to the fourth input terminal;
a first capacitor that couples the first gate terminal and the first input terminal to the fourth source-drain terminal and the fourth input terminal; and
a second capacitor that couples the second gate terminal and the second input terminal to the second source-drain terminal and the third input terminal.

2. The signal combiner of claim 1, wherein the first transistor is configured to provide a first signal to the third input terminal, the first signal has a differential mode component, the second transistor is configured to provide a second signal to the fourth input terminal, and the second signal has a differential mode component that is out of phase with respect to the differential mode component of the first signal.

3. The signal combiner of claim 1, wherein the first transistor has a parasitic gate-drain capacitance, the second transistor has the parasitic gate-drain capacitance, the first capacitor has a first capacitance equal to the parasitic gate-drain capacitance, and the second capacitor has a second capacitance equal to the parasitic gate-drain capacitance.

4. The signal combiner of claim 1, wherein the reference potential comprises a ground potential.

5. The signal combiner of claim 1, wherein the output circuit comprises:
a transformer having first, second, third, and fourth terminals, a primary winding extending between the first and second terminals, and a secondary winding extending between the third and fourth terminals, wherein the first terminal is communicatively coupled to the third input terminal and the second terminal is communicatively coupled to the third input terminal.

6. The signal combiner of claim 5, the output circuit further comprising:
a tank circuit that couples a center tap of the primary winding to a center tap of the secondary winding.

7. The signal combiner of claim 6, the output circuit further comprising:
a third capacitor that couples the center tap of the primary winding to the reference potential; and
a fourth capacitor that couples the center tap of the secondary winding to the reference potential.

8. The signal combiner of claim 7, the output circuit further comprising:
a first amplifier that couples the third input terminal to the first terminal; and
a second amplifier that couples the fourth input terminal to the second terminal.

9. The signal combiner of claim 8, further comprising:
a third amplifier having a first input communicatively coupled to the third terminal, a second input communicatively coupled to the fourth terminal, and an output communicatively coupled to the output terminal of the signal combiner.

10. The signal combiner of claim 6, further comprising:
a substrate, wherein the tank circuit includes an inductor in a figure eight layout on the substrate, the secondary winding is disposed on the substrate and extends at least twice around the inductor, and the primary winding is disposed on the substrate and extends at least twice around the secondary winding.

11. A signal combiner having first and second input terminals and an output terminal, comprising:
an output circuit coupled to the output terminal and having third and fourth input terminals;
a first transistor having a first source-drain terminal coupled to the first input terminal and having a second source-drain terminal coupled to the third input terminal;
a second transistor having a third source-drain terminal coupled to the second input terminal and having a fourth source-drain terminal coupled to the fourth input terminal;
a first capacitor that couples the first source-drain terminal and the first input terminal to the fourth source-drain terminal and the fourth input terminal; and
a second capacitor that couples the third source-drain terminal and the second input terminal to the second source-drain terminal and the third input terminal.

12. The signal combiner of claim 11, further comprising:
a first resistor that couples the first source-drain terminal and the first input terminal to the fourth source-drain terminal and the fourth input terminal in parallel with the first capacitor.

13. The signal combiner of claim 12, further comprising:
a second resistor that couples the third source-drain terminal and the second input terminal to the second source-drain terminal and the third input terminal in parallel with the second capacitor.

14. The signal combiner of claim 13, wherein the first transistor has a parasitic source-drain capacitance and a parasitic source-drain resistance, the second transistor has the parasitic source-drain capacitance and the parasitic source-drain resistance, the first capacitor has a first capacitance equal to the parasitic source-drain capacitance, the second capacitor has a second capacitance equal to the parasitic source-drain capacitance, the first resistor has a first resistance equal to the parasitic source-drain resistance, and the second resistor has a second resistance equal to the parasitic source-drain resistance.

15. The signal combiner of claim 11, wherein the first transistor is configured to provide a first signal to the third input terminal, the first signal has a differential mode component, the second transistor is configured to provide a second signal to the fourth input terminal, and the second signal has a differential mode component that is out of phase with respect to the differential mode component of the first signal.

16. The signal combiner of claim 11, wherein the output circuit comprises:
a transformer having first, second, third, and fourth terminals, a primary winding extending between the first and second terminals, and a secondary winding extending between the third and fourth terminals, wherein the first terminal is communicatively coupled to the third input terminal and the second terminal is communicatively coupled to the third input terminal.

17. The signal combiner of claim 16, the output circuit further comprising:
a tank circuit that couples a center tap of the primary winding to a center tap of the secondary winding;
a third capacitor that couples the center tap of the primary winding to the reference potential; and
a fourth capacitor that couples the center tap of the secondary winding to the reference potential.

18. The signal combiner of claim 17, further comprising:
a substrate, wherein the tank circuit includes an inductor in a figure eight layout on the substrate, the secondary winding is disposed on the substrate and extends at least twice around the inductor, and the primary winding is disposed on the substrate and extends at least twice around the secondary winding.

19. Wireless circuitry comprising:
a phased antenna array that includes a first antenna and a second antenna;
a first transmission line coupled to the first antenna;
a second transmission line coupled to the second antenna; and
a signal combiner that couples the first and second transmission lines to a signal path, wherein the signal combiner includes
an output circuit coupled to the signal path and having first and second input terminals,
a first transistor coupled between the first transmission line and the first input terminal,
a second transistor coupled between the second transmission line and the second input terminal,
a first capacitor that couples the first transmission line to the second input terminal, and
a second capacitor that couples the second transmission line to the first input terminal.

20. The wireless circuitry of claim 19, wherein the signal combiner further comprises:
a first resistor that couples the first transmission line to the second input terminal in parallel with the first capacitor; and
a second resistor that couples the second transmission line to the first input terminal in parallel with the second capacitor.
